(19) United States
(12) Patent Application Publication
(10) Pub. No.: US 2012/0051479 A1
(43) Pub. Date: Mar. 1, 2012

(54) CLOCK FREQUENCY ADJUSTING CIRCUIT AND CLOCK FREQUENCY ADJUSTING METHOD THEREOF

(75) Inventors: Hsiang Sheng LIU, Hsin-Chu (TW); Kun Chih CHANG, Hsin-Chu (TW); Ching Chih CHEN, Hsin-Chu (TW); Chih Pin SUN, Hsin-Chu (TW)

(73) Assignee: PIXART IMAGING INC., Hsin-Chu (TW)

(21) Appl. No.: 13/290,169

(22) Filed: Nov. 7, 2011

Related U.S. Application Data
(63) Continuation-in-part of application No. 12/261,436, filed on Oct. 30, 2008.

(30) Foreign Application Priority Data
May 14, 2008 (TW) 097117664
Jun. 13, 2008 (CN) 200810111074.7

(51) Int. Cl. H04L 7/00

(52) U.S. Cl. 375/371

(57) ABSTRACT

A clock frequency adjusting method includes the steps of: calculating a phase difference between a local signal and SOF signals or EOP signals in an external signal; counting a count value of the phase difference based on a clock frequency of a local oscillator; and adjusting the clock frequency according to the count value. The present invention further provides a clock frequency adjusting circuit.

### CROSS REFERENCE TO RELATED APPLICATION

This application is a continuation-in-part application of U.S. Ser. No. 12/261,436, filed on Oct. 30, 2008, the full disclosure of which is incorporated herein by reference.

### BACKGROUND OF THE INVENTION

1. Field of the Invention

This invention generally relates to a clock frequency adjusting circuit and clock frequency adjusting method thereof, and more particularly, to a clock frequency adjusting circuit and clock frequency adjusting method thereof that can automatically adjust the local oscillator of a USB device.

2. Description of the Related Art

A universal serial bus (USB) system is consisted of a USB host and a USB device connected by a USB interface, wherein the data transmission between the USB host and the USB device has to meet a data transmission specification. For example, in a high-speed device, data transmission needs to be controlled within a range of 480 MHz±0.05%; in a full-speed device, data transmission needs to be controlled within a range of 12 MHz±0.25%; however, in a low-speed device, data transmission needs to be controlled within a range of 1.5 MHz±1.5%. A current method for controlling the clock frequency of a local oscillator in a USB device to meet the above specification is to install a quartz oscillator so as to increase the accuracy of the clock frequency. However, in the chip using a quartz oscillator, it is necessary to add additional 1˜2 pins to connect the quartz oscillator and therefore the cost will be increased.

In a conventional circuit for locking an oscillator, such as U.S. Pat. No. 6,297,705 and entitled “Circuit for locking an oscillator to a data stream”, it utilizes a counter to compare the output frequency of a digital control oscillator with the frequency of a USB device, and coarsely and finely tunes the output frequency of the digital control oscillator until its output frequency synchronizes with the frequency of the USB device. However, the above circuit needs to use the whole signal package to adjust the output frequency and therefore it will take a longer adjustment time.

Another conventional method for regulating an oscillator applicable to a low-speed USB interface, such as U.S. Pat. No. 7,127,628 and entitled “Method for automatically regulating an oscillator”, includes the steps of: (a) providing a voltage-controlled oscillator in a USB interface for generating a controllable oscillating signal to a USB electronic device; (b) feeding back the controllable oscillating signal to a frequency comparing unit for comparing the controllable oscillating signal with a Keep Alive Strobe signal in the USB interface; (c) inputting an output signal of the frequency comparing unit to a frequency regulating unit for changing the frequency of the controllable oscillating signal according to a signal regulating voltage fed back from the frequency comparing unit; and (d) repeating steps (b) and (c) to synchronize the controllable oscillating signal with the Keep Alive Strobe signal in the USB interface; so that the USB interface connecting system and the USB electronic device may be quickly synchronized for data transmission. However, the above method is only limited to a low-speed USB interface connecting system.

When a USB device is connected to a USB interface, the USB device will receive USB differential signals, which begin with a USB reset signal. In each frame time, e.g. 1 ms, of the USB differential signals behind the USB reset signal, the USB device will always receive a Keep Alive signal (for low-speed device) or a start of frame (SOF) signal (for full-speed device) continuously; and a high-speed device will receive a SOF signal every 125 μs. The present invention further provides a clock frequency adjusting circuit and clock frequency adjusting method thereof for automatically adjusting a local oscillator by utilizing these continuous signals so as to effectively reduce the cost, simplify the system circuit and decrease the size of circuit board.

### SUMMARY OF THE INVENTION

It is an object of the present invention to provide a method for automatically adjusting clock frequency and a clock frequency adjusting circuit, wherein an oscillator with an adjustable clock frequency is disposed inside the control IC of a USB device and the clock frequency of the oscillator is adjusted according to Keep Alive signals or SOF signals of the USB interface so as to effectively increase the accuracy of the clock frequency.

It is another object of the present invention to provide a method for automatically adjusting clock frequency and a clock frequency adjusting circuit, wherein it only needs to dispose an oscillator with an adjustable clock frequency inside the control IC of a USB device, without using a quartz oscillator, so as to decrease the cost, simplify the system circuit and reduce the size of the circuit board.

It is another object of the present invention to provide a clock frequency adjusting circuit and clock frequency adjusting method thereof, wherein an oscillator with an adjustable clock frequency is disposed inside the control IC of a USB device, and the clock frequency of the oscillator is adjusted according to a phase difference between SOF signals or EOP signals in a data stream from a USB host and a local signal of the USB device so as to effectively increase the accuracy of the clock frequency.

It is another object of the present invention to provide a clock frequency adjusting circuit and clock frequency adjusting method thereof that can be adapted to low-speed, full-speed and high-speed USB interfaces.

In order to achieve above objects, the present invention provides a clock frequency adjusting circuit includes a clock generating circuit, a data receiver and a calibration unit. The clock generating circuit outputs a clock signal and a local signal. The data receiver receives a USB data stream and outputs a host signal which includes SOF signals or EOP signals. The calibration unit receives the host signal and the local signal, counts a count value of a phase difference between the host signal and the local signal based on the clock signal, and adjusts the clock signal according to the count value.

According to another aspect of the present invention, the present invention further provides a clock frequency adjusting method of a clock frequency adjusting circuit. The clock frequency adjusting circuit includes a clock generating circuit, a calibration unit and a data receiver. The clock frequency adjusting method includes the steps of: receiving a USB data stream and generating a host signal with the data receiver; generating a local signal and a clock signal with the clock generating circuit; receiving the local signal and the host signal to calculate a phase difference, and counting a count value of the phase difference based on the clock signal with the calibration unit; and adjusting a clock frequency of the clock signal according to the count value.

According to another aspect of the present invention, the present invention further provides a clock frequency adjusting method of a clock frequency adjusting circuit. The clock frequency adjusting circuit includes an oscillator, a frequency divider, a phase delay, a phase detector, a control circuit and a data receiver. The clock frequency adjusting method includes the steps of: receiving a USB data stream and generating a host signal with the data receiver; generating an adjustable clock signal with the oscillator; frequency-dividing the clock signal with the frequency divider to generate a frequency-divided signal; delaying the frequency-divided signal a predetermined phase with the phase delay to generate a local signal; receiving the host signal and the local signal with the phase detector to calculate a phase difference; and receiving the phase difference, counting a count value of the phase difference based on the adjustable clock signal, and controlling the oscillator according to the count value with the control circuit.

The clock frequency adjusting circuit and the clock frequency adjusting method of the present invention adjust the clock frequency according to EOP signals or SOF signals outputted by a USB host. Because the EOP signals and the SOF signals are regulated within a very small error range, they can be served as a reference for adjusting the clock frequency of the built-in oscillator of a USB device. In this manner, an additional quartz oscillator needs not to be installed in the USB device related to the present invention so as to effectively reduce the manufacturing cost.

### BRIEF DESCRIPTION OF THE DRAWINGS

Other objects, advantages, and novel features of the present invention will become more apparent from the following detailed description when taken in conjunction with the accompanying drawings.

FIG. 1 shows a timing diagram of differential signals when a USB device is connected to a USB system.

FIG. 2 shows a block diagram of the clock frequency adjusting circuit according to the first embodiment of the present invention.

FIG. 3 shows a flow chart of the clock frequency adjusting method according to the first embodiment of the present invention.

FIG. 4 shows a block diagram of the clock frequency adjusting circuit according to the second embodiment of the present invention.

FIG. 5 shows a timing diagram of an external signal and a local signal received by the phase detector shown in FIG. 4.

FIG. 6 shows another block diagram of the clock frequency adjusting circuit according to the second embodiment of the present invention.

FIG. 7 shows a flow chart of the clock frequency adjusting method according to the second embodiment of the present invention.

### DETAILED DESCRIPTION OF THE PREFERRED EMBODIMENT

It should be noted that, wherever possible, the same reference numbers will be used throughout the drawings to refer to the same or like parts.

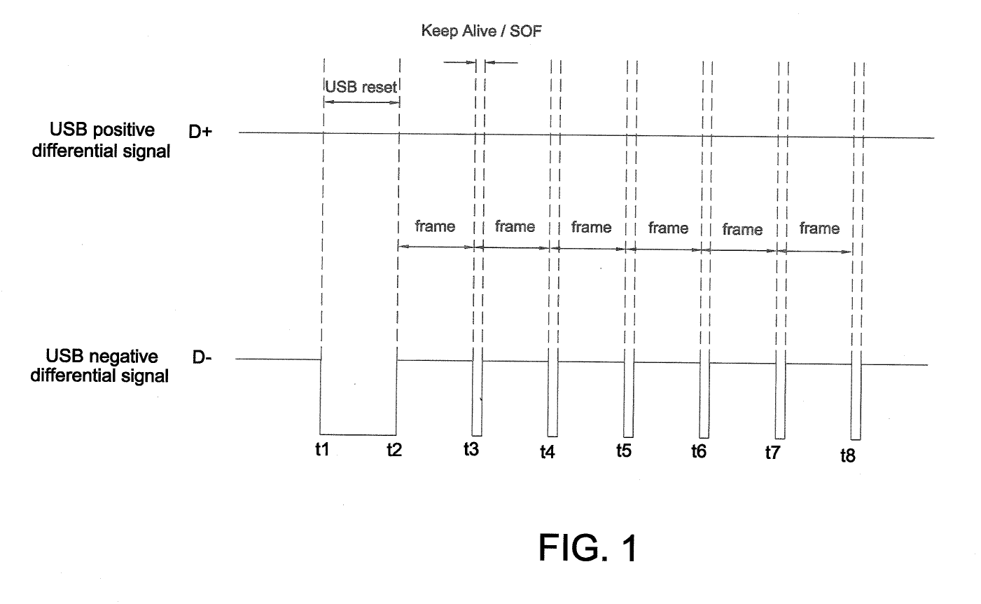

Referring to FIG. 1, it shows a timing diagram of differential signals when a USB device is connected to a USB system according to one embodiment of the present invention, which includes a USB positive differential signal D+ and a USB negative differential signal D−. During the initial period of connection, e.g. a time interval t1˜t2, the USB device will receive a USB reset signal from the USB interface. Then, the USB device will always receive a Keep Alive signal, i.e. end of packet (EOP) signal for low-speed devices, or a start of frame (SOF) signal (for full-speed devices) after each frame time, i.e. 1 ms, such as time intervals t2˜t3, t3˜t4 . . . ; a high-speed device will receive a SOF signal every 125 μs. The present invention uses these signals, i.e. Keep Alive signals or SOF signals, as reference signals for adjusting the oscillator in a USB device.

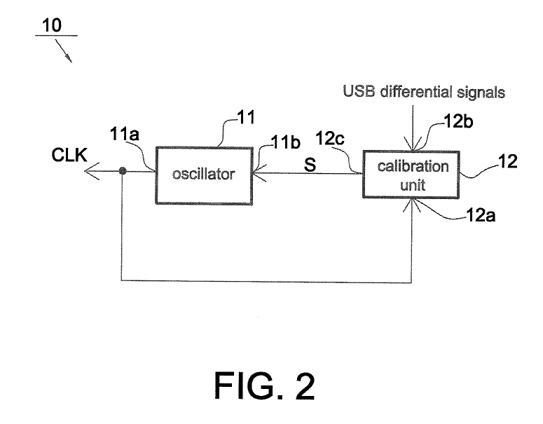

Referring to FIG. 2, it shows a block diagram of the clock frequency adjusting circuit 10 according to the first embodiment of the present invention, wherein the clock frequency adjusting circuit 10 may be adapted to a USB device. The clock frequency adjusting circuit 10 includes an oscillator 11 and a calibration unit 12. The oscillator 11 is for generating a clock signal CLK with an adjustable clock frequency, and has an output 11a and an input 11b. The oscillator 11 may be, but not limited to, an RC oscillator.

Referring to FIGS. 1 and 2 again, the calibration unit 12 is for outputting a control signal S to adjust the frequency of the clock signal CLK outputted from the oscillator 11, and includes a first input 12a, a second input 12b and a signal output 12c. The first input 12a receives the feedback signal of the clock signal CLK generated by the oscillator 11; the second input 12b receives USB differential signals from the USB system. The calibration unit 12 counts the clock signal CLK based on each frame time of the USB differential signals, e.g. t2˜t3, t3˜14 . . . , and generates the control signal S according to a result of counting the clock signal CLK so as to accordingly adjust the frequency of the clock signal CLK generated by the oscillator 11. The control signal S may be, for example, a digital signal. If the oscillator 11 is an RC oscillator, the control signal S can be used to regulate the value of R, value of C, or values of R and C.

In one embodiment, it is assumed that the USB device is a full-speed device. According to the data transmission specification of a USB system, the frequency of the clock signal CLK may be, for example 6 MHz and the frame time between two consecutive SOF signals in USB differential signals is 1 ms; thus a predetermined count value can be obtained as [1 ms/(⅙ MHz)]=6000 and a tolerable error range of the frequency of the clock signal CLK is between ±0.25% of the predetermined count value. That is, a count value obtained by the calibration unit 12 for counting the clock signal CLK based on each frame time of the USB differential signals should be between 5985 and 6015. The clock signal CLK generated by the oscillator 11 will not fix at 6 MHz due to the influence of manufacturing processes and operating environments. When the count value obtained by the calibration unit 12 for counting the clock signal CLK based on each frame time of the USB differential signals is smaller than 5985, meaning that the frequency of the clock signal CLK is too low, the calibration unit 12 generates the control signal S to increase the frequency of the clock signal CLK generated by the oscillator 11. On the contrary, when the obtained count value is higher than 6015, meaning that the frequency of the clock signal CLK is too high, the calibration unit 12 generates the control signal S to decrease the frequency of the clock signal CLK generated by the oscillator 11. It can be understood that, the frequency of the clock signal CLK is not limited to 6 MHz, and it can be integral multiples of 6 MHz, such as 12 MHz, 18 MHz, 24 MHz, and so on. The predetermined count range can be determined according to different clock signal frequencies.

In addition, when the USB device is a low-speed device, according to the data transmission specification of a USB system, the frequency of the clock signal CLK may be 1.5 MHz, and the frame time between two consecutive Keep Alive signals in USB differential signals is also 1 ms; thus a predetermined count value can be determined as 1500 and a tolerable error range of the frequency of the clock signal CLK is between ±1.5% of the predetermined count value. That is, a count value obtained by the calibration unit 12 for counting the clock signal CLK based on each frame time of the USB differential signals should be between 1477.5 and 1522.5. The calibration unit 12 also determines whether the count value exceeds the predetermined count value or not and accordingly generates the control signal S to control the frequency of the clock signal CLK generated by the oscillator 11.

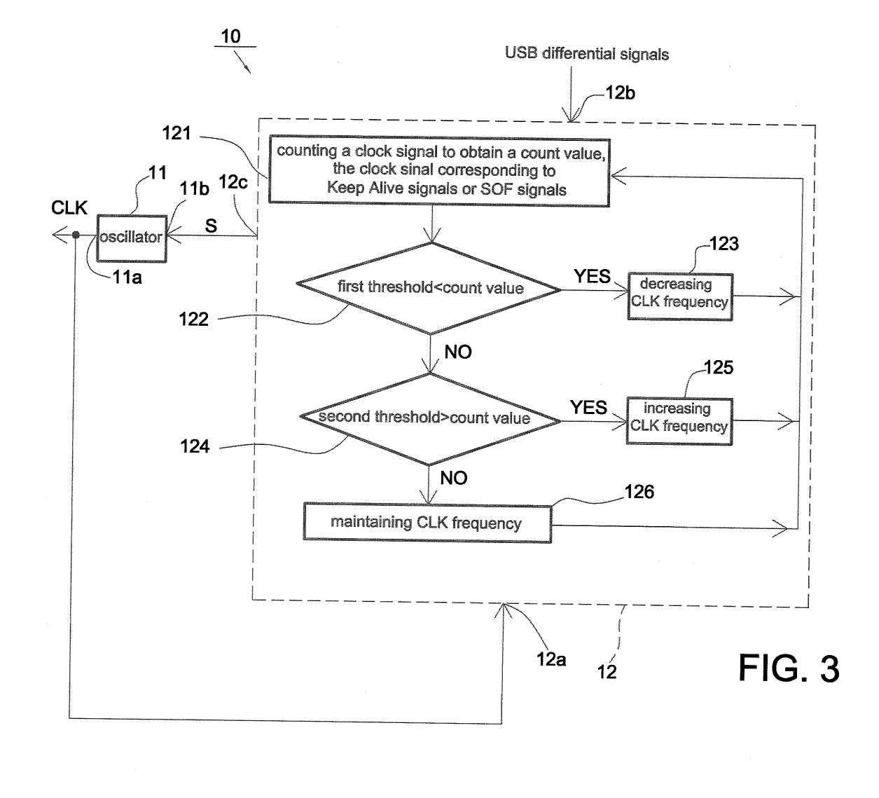

Referring to FIGS. 2 and 3, FIG. 3 shows a flow chart of the clock frequency adjusting method according to the first embodiment of the present invention. Firstly, the oscillator 11 outputs a clock signal CLK with an adjustable frequency from its output 11a, and the clock signal CLK is fed back to the calibration unit 12 through the first input 12a of the calibration unit 12. In the meanwhile, the calibration unit 12 receives the USB differential signals from a USB interface through its second input 12b. Next, the calibration unit 12 counts the clock signal CLK based on each frame time of the USB differential signals and so as to obtain a count value (step 121). The calibration unit 12 determines whether the count value is larger than a first threshold, e.g. 6015 in a full-speed device (step 122). When the count value is larger than the first threshold, the calibration unit 12 generates a control signal S to be transmitted to the oscillator 11 so as to decrease the frequency of the clock signal CLK (step 123); otherwise, the calibration unit 12 then determines whether the count value is smaller than a second threshold, e.g. 5985 in a full-speed device (step 124). When the count value is smaller than the second threshold, the calibration unit 12 generates a control signal S to the oscillator 11 so as to increase the frequency of the clock signal CLK (step 126); otherwise the frequency of the clock signal CLK generated by the oscillator 11 should be maintained unchanged. Then the process returns to step 121 to perform the counting of the clock signal CLK repeatedly. When the frequency of the clock signal CLK appears deviation, the frequency will be adjusted immediately so as to maintain the frequency accuracy of the clock signal CLK generated by the oscillator 11. It should be appreciated that, the sequence of the steps 122, 123 and the steps 124, 125 can be exchanged.

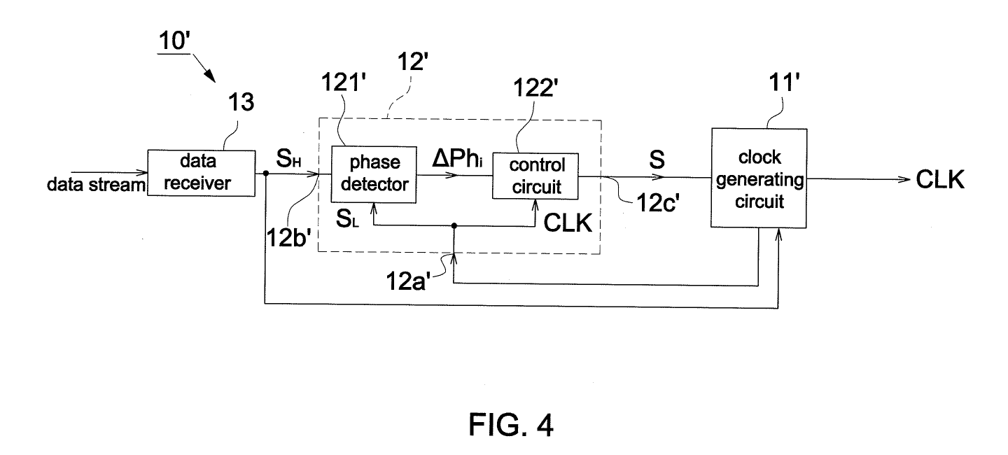

Please refer to FIG. 4, it shows a block diagram of the clock frequency adjusting circuit 10′ according to the second embodiment of the present invention. The clock frequency adjusting circuit 10′ includes a data receiver 13, a calibration unit 12′ and a clock generating circuit 11′. The data receiver 13 receives an external signal, such as a data stream from a USB host, and outputs a host signal S_{H}, which includes SOF signals or EOP signals of the data stream. That is, the data receiver 13 retrieves SOF signals or EOP signals from the data stream.

The calibration unit 12′ includes a phase detector 121′ and a control circuit 122′, and has a first input 12a′, a second input 12b′ and a signal output 12c′. The phase detector 121′ is configured to receive the host signal S_{H} from the data receiver 13 through the second input 12b′, and receive a local signal S_{L} from the clock generating circuit 11′ through the first input 12a′, and calculate and output a phase difference ΔPhi between the host signal S_{H} and the local signal S_{L}. The control circuit 122′ is configured to receive the phase difference ΔPhi and receive a clock signal CLK generated by the clock generating circuit 11′ through the first input 12a′, count a count value of the phase difference ΔPhi based on the clock signal CLK, and output a control signal S through the signal output 12c′ to adjust a clock frequency of the clock signal CLK generated by the clock generating circuit 11′ according to the count value.

The clock generating circuit 11′ is served as the local oscillator circuit of a USB device, and includes an oscillator, preferably a programmable oscillator, to generate the clock signal CLK. The clock generating circuit 11′ is able to adjust the clock frequency of the clock signal CLK according to the received control signal S. The clock generating circuit 11′ also feeds back the clock signal CLK to the control circuit 122′ and outputs the local signal S_{L} to the phase detector 121′. A frequency of the local signal S_{L} is far lower than the clock frequency of the clock signal CLK. In an embodiment, the local signal S_{L} may be a signal frequency-divided and phase-delayed from the clock signal CLK, wherein a divisor of the frequency-dividing may be determined according to the clock frequency of the clock signal CLK and the data stream.

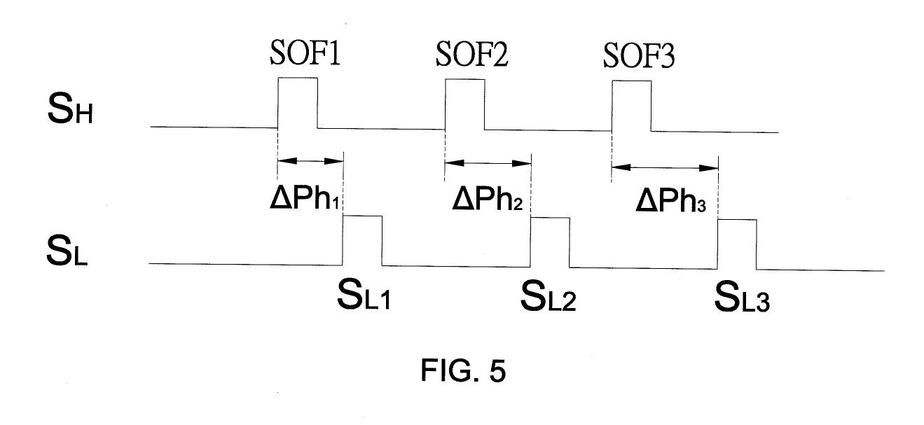

Please refer to FIG. 5, it shows a timing diagram of the host signal S_{H} and the local signal S_{L} received by the phase detector 121′ shown in FIG. 4, wherein there are phase differences ΔPhi (e.g. ΔPh₁ to ΔPh₃) between the host signal S_{H} and the local signal S_{L}. It should be noted that although the phase differences ΔPhi shown in FIG. 5 are between rising edges of the SOF signals of the host signal S_{H} (e.g. SOF1 to SOF3) and rising edges of the pulses of the local signal S_{L} (e.g. S_{L1} to S_{L3}), the present invention is not limited thereto. The phase differences ΔPhi may also between falling edges or other positions of the SOF signals of the host signal S_{H} and the pulses of the local signal S_{L}. In addition, it is appreciated that the host signal S_{H} includes EOP signals in a low-speed device.

In a word, in the clock frequency adjusting circuit 10′ of the present embodiment the data receiver 13 retrieves a host signal S_{H}, e.g. SOF signals or EOP signals, from an external data stream; the calibration unit 12′ calculates a phase difference ΔPhi between the host signal S_{H} and a local signal S_{L}, counts a count value of the phase difference ΔPhi based on a current clock signal CLK generated by the clock generating circuit 11′, and outputs a control signal S according to the count value so as to adjust or maintain the clock frequency of the clock generating circuit 11′; wherein when the local signal S_{L} and the host signal S_{H} have substantially identical frequency (i.e. the phase difference ΔPhi within a predetermined range), the clock generating circuit 11′ outputs identical clock signal CLK; however, when the phase difference ΔPhi between the local signal S_{L} and the host signal S_{H} is larger than a predetermined range (e.g. ±1.5% for low-speed USB interface, ±0.25% for full-speed USB interface and ±0.05% for high-speed USB interface), the calibration unit 12′ controls the clock generating circuit 11′ to adjust the clock frequency of the clock signal CLK.

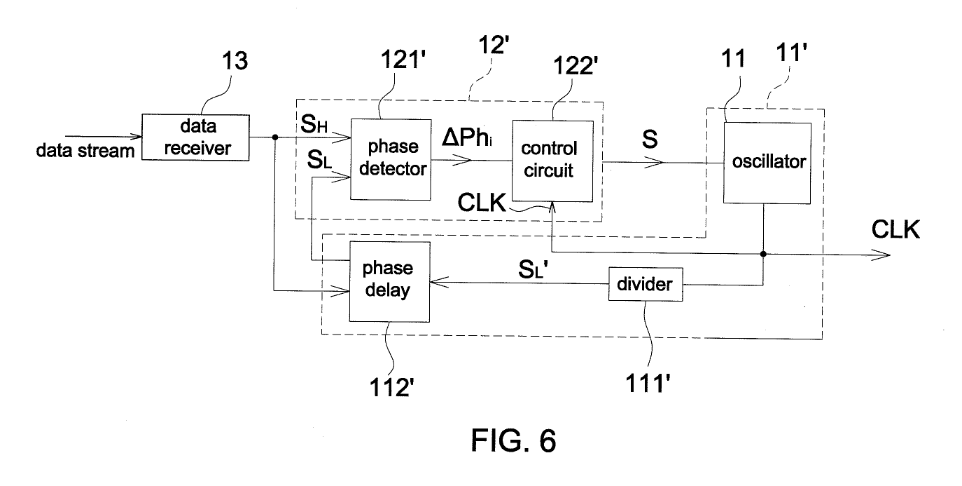

Please refer to FIG. 6, it shows another block diagram of the clock frequency adjusting circuit 10′ according to the second embodiment of the present invention. FIG. 6 shows other components included in the clock generating circuit 11′ shown in FIG. 4; that is, the clock generating circuit 11′ further includes an oscillator 11, a frequency divider 111′ and a phase delay 112′. The oscillator 11 is served as a local oscillator of a USB device configured to generate the clock signal CLK. The clock signal CLK is served as the local clock signal of the USB device and is also fed back to the control circuit 122′ of the calibration unit 12′. The frequency divider 111′ frequency-divides the clock signal CLK to be theoretically identical to the frequency of the SOF signals or EOP signals of the host signal S_{H}. The phase delay 112′ delays a frequency-divided signal S_{L}′ by a predetermined phase to become the local signal S_{L} to be input to the phase detector 121′ of the calibration unit 12′. The data receiver 13 further outputs the host signal S_{H} to the phase delay 112′ to enable to the output of the local signal S_{L}, and the predetermined phase to be delayed is preset by the system. In another embodiment, the frequency divider 111′ and the phase delay 112′ may not be included in the clock generating circuit 11′.

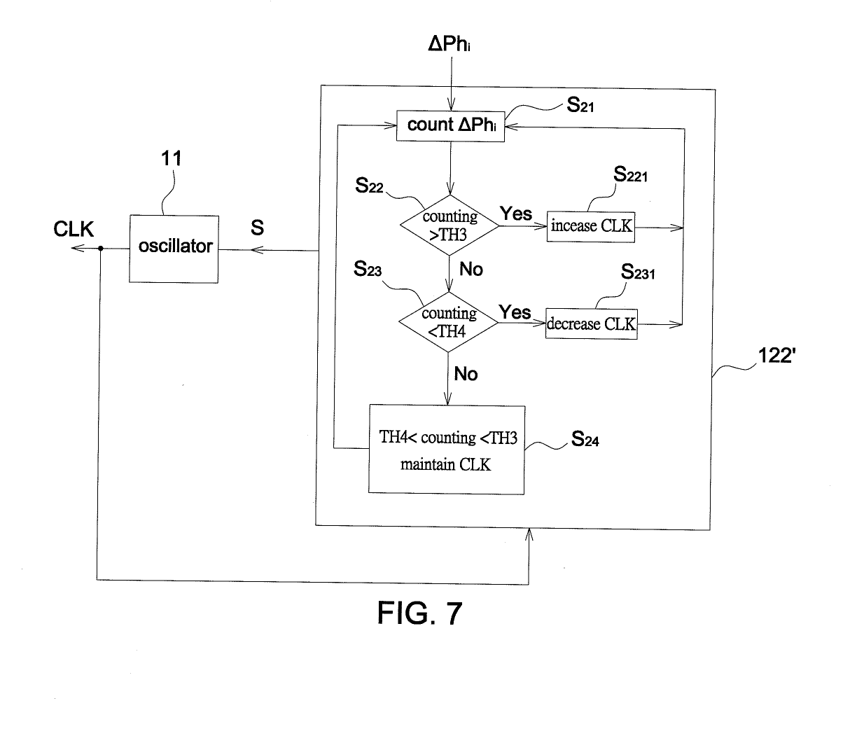

Please refer to FIGS. 6 and 7 together, FIG. 7 shows a flow chart of the clock frequency adjusting method of the clock frequency adjusting circuit 10′ according to the second embodiment of the present invention. In the clock frequency adjusting method of the present embodiment, the control circuit 122′ receives a phase difference ΔPhi between the host signal S_{H} and the local signal S_{L}, and counts a count value of the phase difference ΔPhi based on a current clock frequency of the clock signal CLK (Step S₂₁); next, the control circuit 122′ identifies whether the count value is larger than a third threshold TH3 (Step S₂₂); when the count value is larger than the third threshold TH3, it means that the clock frequency of the oscillator 11 is too low and the control circuit 122′ outputs the control signal S to control the oscillator 11 to increase the clock frequency of the clock signal CLK (Step S₂₂₁); if not, the control circuit 122′ then identifies whether the count value is smaller than a fourth threshold TH4 (Step S₂₃). When the count value is smaller than the fourth threshold TH4, it means that the clock frequency of the oscillator 11 is too fast and the control circuit 122′ outputs the control signal S to control the oscillator 11 to decrease the clock frequency of the clock signal CLK (Step S₂₃₁); if not, its means that the clock frequency of the oscillator 11 is within a predetermined range, and the control circuit 122′ outputs the control signal S to maintain the clock frequency of the clock signal CLK (Step S₂₄). It should be noted that a frequency step that the control circuit 122′ controls the oscillator 11 to increase or decrease the clock frequency is determined according to actual applications and dose not have any limitation. In addition, a sequence of the steps S₂₂, S₂₂₁ and S₂₃, S₂₃₁ is not limited to that shown in FIG. 7, and the sequence may be, for example, converted. In this embodiment, the third threshold TH3 is larger than the fourth threshold TH4.

An embodiment will be given to illustrate the clock frequency adjusting method of the present invention, and a high-speed USB interface will be served as an example herein. In a high-speed USB interface, an initial clock signal CLK output by the oscillator 11 may be, for example, around 48 MHz (referred as f1 herein), and the clock frequency adjusting method of the present invention is to adjust an initial clock frequency (i.e. f1) of the clock signal CLK to be substantially equal to 48 MHz. The frequency-divided signal S_{L}′ outputted by the frequency divider 111′ is around 1 k (e.g. f1/n), wherein n is a divisor of the frequency-dividing. For example, if the host signal S_{H} output by the data receiver 13 is 1 k, the divisor n is 48000. The third threshold and the fourth threshold may be 48 MHz±0.05% respectively. It is appreciated that the clock frequency of the clock signal CLK, the divisor n and the thresholds are determined according to different applications and they are not limited to the values mentioned above.

Please refer to FIGS. 5 to 7 together, when receiving the first SOF (e.g. detecting the rising edge of SOF1), the phase delay 112′ outputs the local signal S_{L} to the phase detector 121′ by delaying a predetermined count value (e.g. 24000 counts) based on the current clock frequency (i.e. f1) of the clock signal CLK; that is, SOF1 may also be used to enable the output of S_{L1}. The phase detector 121′ calculates a phase difference ΔPh₁ between SOF1 and the first pulse S_{L1} of the local signal S_{L}, and transmits the phase difference ΔPh₁ to the control circuit 122′, and the phase difference ΔPh₁ is served as a reference phase difference.

The control circuit 122′ counts a count value of the phase difference ΔPh₁ based on the current clock frequency (i.e. f1) of the clock signal CLK, and the count value is 24000 now which is between the third threshold TH3 and the fourth threshold TH4, and thus the control circuit 122′ does not adjust the current clock frequency f1 of the oscillator 11 (Step S₂₄). The clock generating circuit 11′ continuously generates the local signal S_{L} with the frequency f1/n. In this embodiment, an acceptable error of the clock frequency of the oscillator 11 should be maintained with +0.05%, i.e. the third threshold TH3=24012 and the fourth threshold TH4=23088.

Next, the phase detector 121′ receives the second SOF signal (e.g. SOF2) and a next pulse S_{L2} of the local signal S_{L}, and calculates a phase difference ΔPh₂ therebetween, and transmits the phase difference ΔPh₂ to the control circuit 122′. The control circuit 122′ counts a count value of the phase difference ΔPh₂ based on the current clock frequency (i.e. f1) of the clock signal CLK (Step S₂₁), and compares the count value with the third threshold TH3 and fourth threshold TH4.

When the count value is still between the third threshold TH3 and the fourth threshold TH4, the control circuit 122′ does not adjust the current clock frequency f1 of the oscillator 11 (Step S₂₄), and thus the clock generating circuit 11′ continuously generates the local signal S_{L} with the frequency f1/n. Next, the process returns to Step S₂₁; that is, the control circuit 122′ still counts a count value of the next phase difference ΔPh₃ according to the current clock frequency (i.e. f1) of the clock signal CLK, and determines whether to adjust the current clock frequency f1 of the oscillator 11 according to the count value.

In addition, when the count value is larger than the third threshold TH3 (Step S₂₂), the control circuit 122′ controls the oscillator 11 to increase the clock frequency of the clock signal CLK to f2 (Step S₂₂₁) and the clock generating circuit 11′ outputs the local signal S_{L} with the frequency f2/n. When receiving the next SOF signal (e.g. detecting the rising edge of SOF3), the phase delay 112′ outputs the local signal S_{L} to the phase detector 121′ by delaying a predetermined count value (e.g. 24000 counts) based on the current clock frequency (i.e. 12) of the clock signal CLK. The phase detector 121′ calculates a phase difference ΔPh₃ between SOF3 and the next pulse S_{L3} of the local signal S_{L}, and transmits the phase difference ΔPh₃ to the control circuit 122′. The phase difference ΔPh₃ is served as a new reference phase difference. The process is then returned to step S₂₁ to adjust the current clock frequency 12 of the oscillator 11 according to the phase difference between the SOF signal in the host signal S_{H} and the local signal S_{L}.

In addition, when the count value is smaller than the fourth threshold TH4 (Step S₂₃), the control circuit 122′ controls the oscillator 11 to decrease the clock frequency of the clock signal CLK to f3 (Step S₂₃₁) and the clock generating circuit 11′ outputs the local signal S_{L} with the frequency f3/n. When receiving the next SOF signal (e.g. detecting the rising edge of SOF3), the phase delay 112′outputs the local signal S_{L} to the phase detector 121′ by delaying a predetermined count value (e.g. 24000 counts) based on the current clock frequency (i.e. f3) of the clock signal CLK. The phase detector 121′ calculates a phase difference ΔPh₃ between SOF3 and the next pulse S_{L3} of the local signal S_{L}, and transmits the phase difference ΔPh₃ to the control circuit 122′. The phase difference ΔPh₃ is served as a new reference phase difference. The process is then returned to step S₂₁ to adjust the current clock frequency f3 of the oscillator 11 according to the phase difference between the SOF signal in the host signal S_{H} and the local signal S_{L}.

As mentioned above, in conventional art, the method to increase the accuracy of oscillating frequency by installing a quartz oscillator inside the chip of a USB device will increase the cost and circuit complexity. In the present invention, the clock frequency of an oscillator can be dynamically adjusted by installing an oscillator with an adjustable frequency inside the chip of a USB device as well as using the EOP signals or SOF signals of the USB differential signal as a reference for adjusting the clock frequency. The frequency accuracy can be increased and the cost can be reduced at the same time.

Although the invention has been explained in relation to its preferred embodiment, it is not used to limit the invention. It is to be understood that many other possible modifications and variations can be made by those skilled in the art without departing from the spirit and scope of the invention as hereinafter claimed.

What is claimed is:

1. A clock frequency adjusting circuit, comprising:
a clock generating circuit for outputting a clock signal and a local signal;
a data receiver for receiving a USB data stream and outputting a host signal which includes SOF signals or EOP signals; and
a calibration unit for receiving the host signal and the local signal, counting a count value of a phase difference between the host signal and the local signal based on the clock signal, and adjusting the clock signal according to the count value.

2. The clock frequency adjusting circuit as claimed in claim 1, wherein the calibration unit further identifies whether the count value is within a predetermined range to accordingly adjust or maintain a clock frequency of the clock signal.

3. The clock frequency adjusting circuit as claimed in claim 2, wherein
the calibration unit increases the clock frequency when identifying that the count value is larger than a third threshold;
the calibration unit decreases the clock frequency when identifying that the count value is smaller than a fourth threshold; and
the calibration unit maintains the clock frequency when identifying that the count value is between the third threshold and the fourth threshold, wherein the third threshold is larger than the fourth threshold.

4. The clock frequency adjusting circuit as claimed in claim 1, wherein the local signal is a signal frequency-divided and phase-delayed from the clock signal.

5. The clock frequency adjusting circuit as claimed in claim 1, wherein the clock generating circuit further comprises an oscillator, a frequency divider and a phase delay; the oscillator generates the clock signal and feeds back the clock signal to the calibration unit; the frequency divider divides the clock signal to generate a frequency-divided signal; and the phase delay delays the frequency-divided signal to output the local signal to the calibration unit.

6. The clock frequency adjusting circuit as claimed in claim 1, wherein the clock generating circuit further receives the host signal from the data receiver to enable the output of the local signal.

7. The clock frequency adjusting circuit as claimed in claim 1, wherein the calibration unit further comprises a phase detector and a control circuit; the phase detector receives the host signal and the local signal, and outputs the phase difference; and the control circuit counts the count value of the phase difference based on the clock signal, and adjusts the clock signal according to the count value.

8. The clock frequency adjusting circuit as claimed in claim 7, wherein the clock generating circuit further comprises an oscillator, a frequency divider and a phase delay; the oscillator generates the clock signal and feeds back the clock signal to the control circuit; the frequency divider divides the clock signal to generate a frequency-divided signal; and the phase delay delays the frequency-divided signal to output the local signal to the phase detector.

9. A clock frequency adjusting method of a clock frequency adjusting circuit, the clock frequency adjusting circuit comprising a clock generating circuit, a calibration unit and a data receiver, the clock frequency adjusting method comprising the steps of:
receiving a USB data stream and generating a host signal with the data receiver;
generating a local signal and a clock signal with the clock generating circuit;
receiving the local signal and the host signal to calculate a phase difference, and counting a count value of the phase difference based on the clock signal with the calibration unit; and
adjusting a clock frequency of the clock signal according to the count value.

10. The clock frequency adjusting method as claimed in claim 9, wherein the step of adjusting a clock frequency of the clock signal according to the count value further comprises: identifying whether the count value is within a predetermined range to accordingly adjust or maintain the clock frequency of the clock signal.

11. The clock frequency adjusting method as claimed in claim 10, further comprising the steps of:
increasing the clock frequency when the count value is larger than a third threshold;
decreasing the clock frequency when the count value is smaller than a fourth threshold; and
maintaining the clock frequency when the count value is between the third threshold and the fourth threshold.

12. The clock frequency adjusting method as claimed in claim 10, wherein the predetermined range is a predetermined count value ±0.05%±0.25% or ±1.5% of the predetermined count value.

13. The clock frequency adjusting method as claimed in claim 9, further comprising the steps of:
frequency-dividing the clock signal with the clock generating circuit to generate a frequency-divided signal; and
phase-delaying the frequency-divided signal with the clock generating circuit to generate the local signal.

14. The clock frequency adjusting method as claimed in claim 9, further comprising: receiving the host signal with the clock generating circuit to enable the clock generating circuit to output the local signal.

15. A clock frequency adjusting method of a clock frequency adjusting circuit, the clock frequency adjusting circuit comprises an oscillator, a frequency divider, a phase delay, a phase detector, a control circuit and a data receiver, the clock frequency adjusting method comprising the steps of:
receiving a USB data stream and generating a host signal with the data receiver;
generating an adjustable clock signal with the oscillator;
frequency-dividing the clock signal with the frequency divider to generate a frequency-divided signal;
delaying the frequency-divided signal a predetermined phase with the phase delay to generate a local signal;
receiving the host signal and the local signal with the phase detector to calculate a phase difference; and
receiving the phase difference, counting a count value of the phase difference based on the adjustable clock signal, and controlling the oscillator according to the count value with the control circuit.

16. The clock frequency adjusting method as claimed in claim 15, further comprising: receiving the host signal with the phase delay from the data receiver to enable the output of the local signal.

17. The clock frequency adjusting method as claimed in claim 15, wherein in the step of controlling the oscillator according to the count value, the control circuit identifies whether the count value is within a predetermined range to accordingly adjust or maintain a clock frequency of the oscillator.

18. The clock frequency adjusting method as claimed in claim 17, further comprising the steps of:
increasing the clock frequency when the count value is larger than a third threshold;
decreasing the clock frequency when the count value is smaller than a fourth threshold; and
maintaining the clock frequency when the count value is between the third threshold and the fourth threshold, wherein the third threshold is larger than the fourth threshold.

19. The clock frequency adjusting method as claimed in claim 15, wherein the predetermined phase is determined according to a predetermined count of the clock frequency.

20. The clock frequency adjusting method as claimed in claim 15, wherein the host signal includes SOF signals or EOP signals.
